(19) United States
(12) Patent Application Publication
(10) Pub. No.: US 2026/0287941 A1
(43) Pub. Date: Sep. 24, 2026

(54) ELECTROABSORPTION MODULATOR

(71) Applicant: Optoway Technology Inc., Hsin Chu (TW)

(72) Inventors: Meng-Lun Tsai, Taoyuan City (TW); Jung-Wei Yen, Hsinchu County (TW)

(73) Assignee: Optoway Technology Inc., Hsin Chu (TW)

(21) Appl. No.: 19/198,153

(22) Filed: May 5, 2025

(30) Foreign Application Priority Data
Mar. 21, 2025 (TW) 114110769

(51) Int. Cl. G02F 1/025; G02F 1/015

(52) U.S. Cl. CPC G02F 1/025; G02F 1/0151

(57) ABSTRACT

An electroabsorption modulator is provided. The electroabsorption modulator includes: a substrate; a waveguide region, located on a first surface of the substrate and including an optical waveguide and a pair of trenches, wherein the pair of trenches are located on two sides of the optical waveguide and have a first depth; at least one groove, located on an outer side of the waveguide region and having a second depth greater than the first depth; and a first dielectric layer, located in the groove, wherein the first dielectric layer includes a central portion, and a first thickness of the central portion of the first dielectric layer is substantially equal to the second depth.

### CROSS-REFERENCE TO RELATED APPLICATION

This application claims the priority benefit of Taiwan application serial no. 114110769, filed on Mar. 21, 2025. The entirety of the above-mentioned patent application is hereby incorporated by reference herein and made a part of this specification.

### BACKGROUND

### Technical Field

The disclosure relates to an electroabsorption modulator.

### Description of Related Art

Electroabsorption modulators play an important role in long-distance optical fiber communication and have the potential to be integrated into optoelectronic integrated circuits. A capacitance value of the electroabsorption modulator (EAM) is critical to modulation performance, directly affecting modulation speed, power consumption, and signal quality. An RC time constant is determined by a capacitance (C) and a driving resistance (R). Excessive capacitance increases the RC constant, reduces modulation speed, and limits applications in high-speed communication. In addition, excessive capacitance limits a frequency response range, causing high-frequency signal attenuation and affecting signal integrity. To optimize performance, a low-capacitance design may be adopted, such as increasing an active layer thickness, improving electrode arrangement, and selecting a material having a low dielectric constant. These methods may improve bandwidth, help high-frequency modulation performance, and improve signal quality. However, reducing capacitance may increase manufacturing difficulty and cost. Therefore, a balance between performance and economy is needed. Capacitance optimization is a core issue in EAM design and is critical to achieving efficient and high-speed optical communication.

### SUMMARY

In response to the issue above, the disclosure provides an electroabsorption modulator, where a capacitance value of an element may be reduced to improve modulation speed.

In an embodiment of the disclosure, an electroabsorption modulator is provided. The electroabsorption modulator includes a substrate and a waveguide region that is located on a first surface of the substrate. The waveguide region includes an optical waveguide and a pair of trenches. The pair of trenches are located on two sides of the optical waveguide. The trench has a first depth. The electroabsorption modulator includes at least one groove that is located on an outer side of the waveguide region and has a second depth. The second depth is greater than the first depth. The electroabsorption modulator also includes a first dielectric layer located in the groove. The first dielectric layer includes a central portion. A first thickness of the central portion of the first dielectric layer is substantially equal to the second depth.

In some embodiments, the second depth is at least greater than 3 micrometers.

In some embodiments, a refractive index of the first dielectric layer is 1.4 to 1.6.

In some embodiments, a material of the first dielectric layer includes a silicon oxide.

In some embodiments, a second dielectric layer is further included. The second dielectric layer is located over the first dielectric layer and covers at least a portion of the first dielectric layer.

In some embodiments, a refractive index of the second dielectric layer is greater than a refractive index of the first dielectric layer.

In some embodiments, the refractive index of the second dielectric layer is 1.7 to 2.2.

In some embodiments, a material of the second dielectric layer includes a silicon nitride.

In some embodiments, the first dielectric layer further includes a periphery portion. The periphery portion surrounds the central portion. A second thickness of the periphery portion of the first dielectric layer is less than the first thickness.

In some embodiments, a recess region is further included. The recess region is formed on the first surface of the substrate and surrounds the groove.

In some embodiments, the recess region has a third depth, and the third depth is less than the first depth of the trench.

In some embodiments, the third depth of the recess region is greater than 0 nm and less than or equal to 100 nm.

In some embodiments, an electrode is further included. The electrode is located over the groove and extends to one of the pair of trenches and the optical waveguide.

In some embodiments, a third dielectric layer is further included. The third dielectric layer is located over the groove and between the first dielectric layer and the electrode and covers the first dielectric layer. A width of the third dielectric layer is greater than or equal to a width of the groove, and the third dielectric layer partially overlaps with the electrode.

In some embodiments, a refractive index of the third dielectric layer is less than or equal to a refractive index of the first dielectric layer.

In some embodiments, a waterproof layer is further included. The waterproof layer is located over the substrate except over the optical waveguide.

In some embodiments, the waterproof layer is a stack structure of a silicon oxide and a silicon nitride.

In an embodiment of the disclosure, an electroabsorption modulator is provided. The electroabsorption modulator includes a substrate and a waveguide region that is located on a first surface of the substrate. The waveguide region includes an optical waveguide. The substrate under the optical waveguide has a multi-quantum well structure. The multi-quantum well structure has a bottom portion. The electroabsorption modulator includes at least one groove that is located on an outer side of the waveguide region and has a depth. The depth exceeds the bottom portion of the multi-quantum well structure. The electroabsorption modulator also includes a first dielectric layer located in the groove. The first dielectric layer includes a central portion. A first thickness of the central portion of the first dielectric layer is substantially equal to the depth of the groove.

In some embodiments, a second dielectric layer is further included. The second dielectric layer is located over the first dielectric layer and covers at least a portion of the first dielectric layer.

In some embodiments, the first dielectric layer further includes a periphery portion. The periphery portion surrounds the central portion. A second thickness of the periphery portion of the first dielectric layer is less than the first thickness.

Based on the above, in this disclosure, an electroabsorption modulator is provided. The electroabsorption modulator has technical features such as a dielectric layer located in a groove on an outer side of the waveguide region and having a thickness substantially equal to a depth of the groove. A thicker dielectric layer may result in a lower capacitance value of the electroabsorption modulator. Therefore, bandwidth may be increased to form a high-speed electroabsorption modulator.

To make the features and advantages of the disclosure more comprehensible, several embodiments accompanied with drawings are described in detail as follows.

### BRIEF DESCRIPTION OF THE DRAWINGS

FIGS. 1 to 5 are cross-sectional schematic diagrams of a forming method of an electroabsorption modulator according to an embodiment of the disclosure.

### DESCRIPTION OF THE EMBODIMENTS

The drawings of the embodiments are referred to for a more comprehensive description of the disclosure. However, the disclosure may also be embodied in various forms and should not be limited to the embodiments described herein. The sizes and distances in the drawings are drawn for visual clarity and are not original sizes and distances. The same or similar reference numerals indicate the same or similar elements, which will not be repeated in the following paragraphs.

The term “contact” used herein may refer to physical contact and/or electrical contact.

The terms “about,” “approximately,” “substantially,” or “essentially” used herein include the mentioned value and an average value within an acceptable deviation range of a specific value that may be determined by a person having ordinary knowledge in the art, considering a specific amount of the measurement and measurement-related errors under discussion (i.e., limitations of the measurement system). For example, “about” may refer to within one or more standard deviations of the mentioned value, or within ±30%, ±20%, ±10%, or ±5%. Furthermore, the terms “about,” “approximately,” “substantially,” or “essentially” used herein may, depending on optical properties, etching properties, or other properties, select a more acceptable deviation range or standard deviation, and a single standard deviation may not be applicable to all properties.

The terminology used herein is only for describing the exemplary embodiments and not intended to limit the disclosure. In this case, unless otherwise explained in the context, singular forms include plural forms.

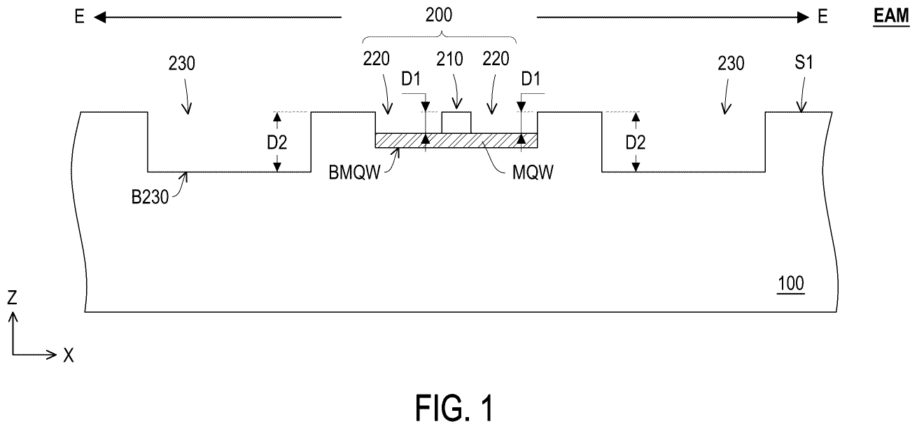

FIGS. 1 to 5 are cross-sectional schematic diagrams of a forming method of an electroabsorption modulator according to an embodiment of the disclosure.

First, referring to FIG. 1, an electroabsorption modulator EAM includes a substrate 100 and a waveguide region 200 located on a first surface S1 of the substrate 100. The waveguide region 200 includes an optical waveguide 210 and a pair of trenches 220 located on two sides of the optical waveguide 210. The trench 220 has a first depth D1. The electroabsorption modulator EAM includes at least one groove 230 located on an outer side E of the waveguide region 200. The groove 230 has a second depth D2, and the second depth D2 of the groove 230 is greater than the first depth D1 of the trench 220 of the waveguide region 200. In this embodiment, the optical waveguide is described as a ridge waveguide structure. In another embodiment, the optical waveguide may also be a buried heterojunction waveguide.

In some embodiments, the substrate 100 may include a semiconductor substrate, but is not limited thereto.

In some embodiments, the optical waveguide 210 may include a semiconductor material doped with a P-type dopant or a semiconductor material doped with an N-type dopant, for example, a semiconductor material P-type InP, but is not limited thereto.

In addition, in some embodiments, the substrate 100 under the optical waveguide 210 includes a multi-quantum well structure MQW. The multi-quantum well structure MQW may include an intrinsic semiconductor not doped with a P-type dopant or an N-type dopant, for example, semiconductor materials AlInGaP, InGaAsP, and the like, but is not limited thereto.

Then, by using various patterning processes such as photolithographic etching, a pair of trenches 220 located on two sides of the optical waveguide 210 and at least one groove 230 located on the outer side E of the waveguide region 200 are formed on the first surface S1 of the substrate 100. The groove 230 has the second depth D2 greater than the first depth D1 of the trench 220 of the waveguide region 200.

In some embodiments, the second depth D2 of the groove 230 exceeds a bottom portion BMQW of the multi-quantum well structure MQW. That is, as shown in FIG. 1, a bottom portion B230 of the groove 230 is farther from the first surface S1 of the substrate 100 in a vertical direction Z than the bottom portion BMQW of the multi-quantum well structure MQW is from the first surface S1 of the substrate 100 in the vertical direction Z.

In some embodiments, the second depth D2 of the groove 230 is at least greater than 3 micrometers.

In addition, a formation order of the trench 220 and the groove 230 is not particularly limited. The trench 220 and the groove 230 may be formed at the same time, formed sequentially, or formed in other orders.

In some embodiments, at least one groove 230 located on the outer side E of the waveguide region 200 is included. For example, as shown in FIG. 1, the grooves 230 are respectively located on left and right outer sides E of the waveguide region 200, but the disclosure is not limited thereto.

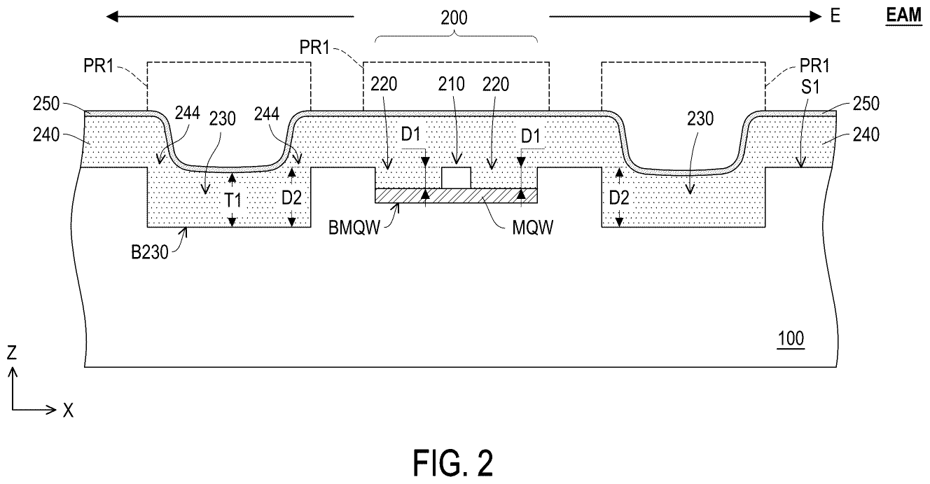

Next, referring to FIG. 2, a first dielectric layer 240 is formed on the first surface S1 of the substrate 100. The first dielectric layer 240 completely fills the trench 220 and the groove 230. A first thickness T1 of a central portion 242 of the first dielectric layer 240 located in the groove 230 is substantially equal to the second depth D2 of the groove 230.

Next, still as shown in FIG. 2, a second dielectric layer 250 is formed on the first dielectric layer 240 to cover the first dielectric layer 240.

The first dielectric layer 240 has a thickness of about 8 to 12 micrometers. In addition, the second dielectric layer 250 has a thickness of about 20 nm to 500 nm.

Further, since the first dielectric layer 240 and the second dielectric layer 250 are conformally formed on the substrate 100 having the trench 220 and the groove 230, and due to the deposition of the first thickness T1 by the first dielectric layer 240, a distance in the vertical direction Z from the second dielectric layer 250 on a periphery portion 244 of the first dielectric layer 240 in the groove 230 to a bottom portion B230 of the groove 230 is naturally greater than a distance in the vertical direction Z from the second dielectric layer 250 on a central portion 242 of the first dielectric layer 240 in the groove 230 to the bottom portion B230 of the groove 230. The periphery portion 244 surrounds the central portion 242. That is, the second dielectric layer 250 on the periphery portion 244 of the first dielectric layer 240 in the groove 230 is higher than the second dielectric layer 250 on the central portion 242 of the first dielectric layer 240 in the groove 230, as shown in FIG. 2.

In some embodiments, a densification of the second dielectric layer is higher than that of the first dielectric layer. The second dielectric layer is used to protect the first dielectric layer in subsequent processing. However, the disclosure is not limited thereto.

In some embodiments, a refractive index of the first dielectric layer 240 is about 1.4 to 1.6.

In some embodiments, the first dielectric layer 240 may include a dielectric material such as silicon oxide (SiOx), but is not limited thereto.

In some embodiments, a refractive index of the second dielectric layer 250 is greater than a refractive index of the first dielectric layer 240. For example, the refractive index of the second dielectric layer 250 is about 1.7 to 2.2.

In some embodiments, the second dielectric layer 250 may include a dielectric material such as silicon nitride (SiNx), but is not limited thereto.

In some embodiments, the second dielectric layer 250 may not be formed on the first dielectric layer 240.

Then, still referring to FIG. 2, a patterned first mask layer PR1 is formed on the electroabsorption modulator EAM. For example, a patterned photoresist layer is formed. The patterned first mask layer PR1 covers the waveguide region 200, and covers the second dielectric layer 250 and the first dielectric layer 240 over the groove 230.

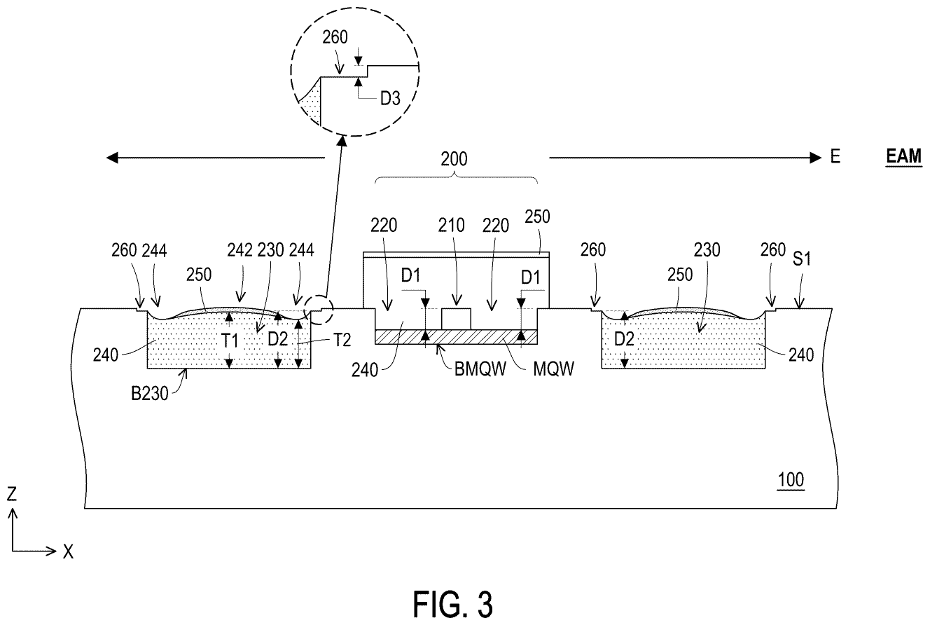

Next, please refer to FIGS. 2 and 3 at the same time.

First, with the patterned first mask layer PR1 present, a dry etching process is performed so that the second dielectric layer 250 and the first dielectric layer 240 between the waveguide region 200 and the groove 230 are disconnected, as shown in FIG. 3.

Further, as described above, since the second dielectric layer 250 on the periphery portion 244 of the first dielectric layer 240 in the groove 230 is higher than the second dielectric layer 250 on the central portion 242 of the first dielectric layer 240 in the groove 230, over-etching may be performed to remove the second dielectric layer 250 and a portion of the first dielectric layer 240 on the periphery portion 244 of the first dielectric layer 240 in the groove 230. The second dielectric layer 250 located over the first dielectric layer 240 covers at least a portion of the first dielectric layer 240. More specifically, that is, after the over-etching process, the second dielectric layer 250 is located only in the central portion 242 of the first dielectric layer 240 in the groove 230.

Further, since a portion of the periphery portion 244 of the first dielectric layer 240 in the groove 230 is removed through over-etching, a second thickness T2 of the periphery portion 244 of the first dielectric layer 240 is less than the first thickness T1 of the central portion 242 of the first dielectric layer 240, as shown in FIG. 3.

Further, as shown in FIG. 2, the region between the waveguide region 200 and the groove 230 that is not covered by the first mask layer PR1 undergoes both the dry etching and over-etching processes. Therefore, a recess region 260 may be formed on the first surface S1 of the substrate 100 in the region between the waveguide region 200 and the groove 230. From a top view facing the first surface S1 of the substrate 100, the recess region 260 surrounds the groove 230. In addition, if the first dielectric layer 240 on this region of the substrate 100 happens to be completely removed through the dry etching and over-etching processes, the recess region 260 may also not be formed.

The recess region 260 has a third depth D3. As shown in the enlarged view of the recess region 260 in FIG. 3, the third depth D3 of the recess region 260 is less than the second depth D2 of the groove 230. Also, the third depth D3 of the recess region 260 is less than the first depth D1 of the trench 220.

In some embodiments, the third depth D3 of the recess region 260 is greater than 0 nm and less than or equal to 100 nm.

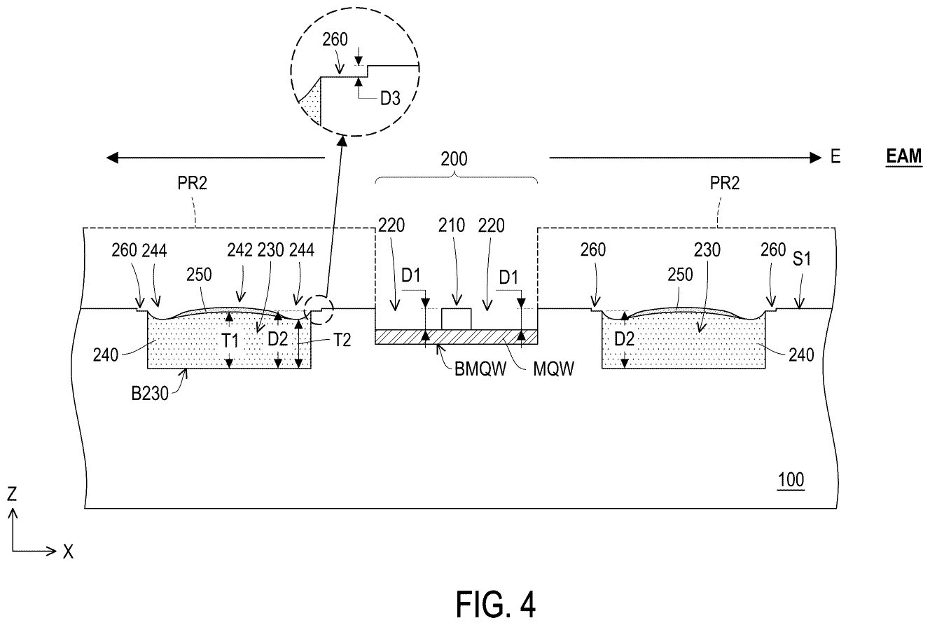

Next, continuing with FIG. 4, a patterned second mask layer PR2 is formed on the electroabsorption modulator EAM. For example, a patterned photoresist layer is formed. The patterned second mask layer PR2 exposes the waveguide region 200. Then, through various etching processes, the second dielectric layer 250 and the first dielectric layer 240 in the waveguide region 200 are removed. For example, wet etching and other processes may be performed to remove the second dielectric layer 250 and the first dielectric layer 240 in the waveguide region 200, but the disclosure is not limited thereto.

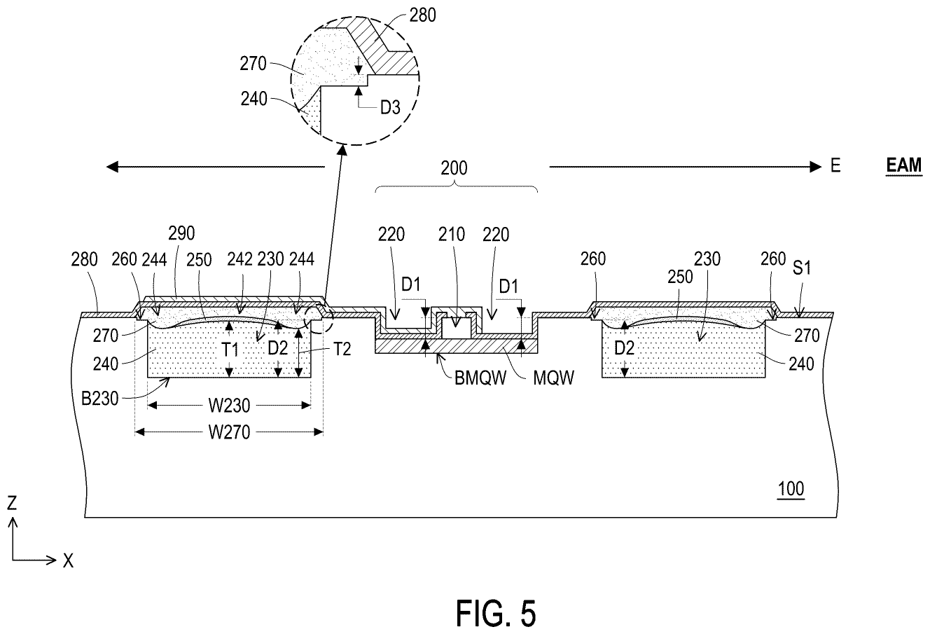

Next, referring to FIG. 5, a third dielectric layer 270 may be formed over the groove 230 of the electroabsorption modulator EAM to cover the first dielectric layer 240 and the second dielectric layer 250 in the groove 230. A width W270 of the third dielectric layer 270 in a horizontal direction X is greater than or equal to a width W230 of the groove 230, as shown in FIG. 5.

In some embodiments, a refractive index of the third dielectric layer 270 is less than or equal to a refractive index of the first dielectric layer 240.

In some embodiments, the third dielectric layer 270 may be used to further reduce a capacitance value.

In some embodiments, the first dielectric layer 240 and the third dielectric layer 270 have the same material.

Continuing with FIG. 5, the electroabsorption modulator EAM further includes a waterproof layer 280. The waterproof layer 280 is located over the substrate 100 except over the optical waveguide 210. That is, the waterproof layer 280 does not cover the optical waveguide 210.

In some embodiments, the waterproof layer 280 may be, for example, a stack structure of silicon oxide (SiOx) and silicon nitride (SiNx), but is not limited thereto.

Further, continuing with FIG. 5, the electroabsorption modulator EAM further includes an electrode 290. The electrode 290 is located over the groove 230 and extends to one of the pair of trenches 220 of the waveguide region 200 and the optical waveguide 210.

Therefore, the third dielectric layer 270 is located between the first dielectric layer 240 and the electrode 290, and partially overlaps with the electrode 290.

Since the waterproof layer 280 is located over the substrate 100 except over the optical waveguide 210, the electrode 290 may electrically contact the optical waveguide 210 exposed from the waterproof layer 280.

In summary, since the electroabsorption modulator of the disclosure has the dielectric layer in the groove located on the outer side of the waveguide region, and the dielectric layer has a thickness substantially equal to a depth of the groove, the thick dielectric layer may reduce a capacitance value of the electroabsorption modulator. Therefore, power loss may be reduced, and a fast-modulating electroabsorption modulator may be formed. And because a thickness of the dielectric layer in the groove is substantially equal to the depth of the groove, problems such as incomplete coverage or short circuit during formation of the waterproof layer or the electrode due to an overly thick dielectric layer may be avoided, and process stability may be increased.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An electroabsorption modulator, comprising:
a substrate;
a waveguide region, located on a first surface of the substrate, the waveguide region comprising:
an optical waveguide, and
a pair of trenches, located on two sides of the optical waveguide, wherein the trench has a first depth;
at least one groove, located on an outer side of the waveguide region and having a second depth, wherein the second depth is greater than the first depth; and
a first dielectric layer, located in the groove, wherein the first dielectric layer comprises a central portion, and a first thickness of the central portion of the first dielectric layer is substantially equal to the second depth.

2. The electroabsorption modulator according to claim 1, wherein the second depth is at least greater than 3 micrometers.

3. The electroabsorption modulator according to claim 1, wherein a refractive index of the first dielectric layer is 1.4 to 1.6.

4. The electroabsorption modulator according to claim 1, wherein a material of the first dielectric layer comprises a silicon oxide.

5. The electroabsorption modulator according to claim 1, further comprising:
a second dielectric layer, located over the first dielectric layer and covering at least a portion of the first dielectric layer.

6. The electroabsorption modulator according to claim 5, wherein a refractive index of the second dielectric layer is greater than a refractive index of the first dielectric layer.

7. The electroabsorption modulator according to claim 6, wherein the refractive index of the second dielectric layer is 1.7 to 2.2.

8. The electroabsorption modulator according to claim 7, wherein a material of the second dielectric layer comprises a silicon nitride.

9. The electroabsorption modulator according to claim 1, wherein the first dielectric layer further comprises a periphery portion, the periphery portion surrounding the central portion, wherein a second thickness of the periphery portion of the first dielectric layer is less than the first thickness.

10. The electroabsorption modulator according to claim 1, further comprising:
a recess region, formed on the first surface of the substrate and surrounding the groove.

11. The electroabsorption modulator according to claim 10, wherein the recess region has a third depth, and the third depth is less than the first depth of the trench.

12. The electroabsorption modulator according to claim 11, wherein the third depth of the recess region is greater than 0 nm and less than or equal to 100 nm.

13. The electroabsorption modulator according to claim 1, further comprising:
an electrode, located over the groove and extending to one of the pair of trenches and the optical waveguide.

14. The electroabsorption modulator according to claim 13, further comprising:
a third dielectric layer, located over the groove and between the first dielectric layer and the electrode, and covering the first dielectric layer, wherein a width of the third dielectric layer is greater than or equal to a width of the groove, and the third dielectric layer partially overlaps with the electrode.

15. The electroabsorption modulator according to claim 14, wherein a refractive index of the third dielectric layer is less than or equal to a refractive index of the first dielectric layer.

16. The electroabsorption modulator according to claim 1, further comprising:
a waterproof layer, located over the substrate except over the optical waveguide.

17. The electroabsorption modulator according to claim 16, wherein the waterproof layer is a stack structure of a silicon oxide and a silicon nitride.

18. An electroabsorption modulator, comprising:
a substrate;
a waveguide region, located on a first surface of the substrate, the waveguide region comprising:
an optical waveguide,
wherein the substrate under the optical waveguide has a multi-quantum well structure, and the multi-quantum well structure has a bottom portion;
at least one groove, located on an outer side of the waveguide region and having a depth, wherein the depth exceeds the bottom portion of the multi-quantum well structure; and
a first dielectric layer, located in the groove, wherein the first dielectric layer comprises a central portion, and a first thickness of the central portion of the first dielectric layer is substantially equal to the depth of the groove.

19. The electroabsorption modulator according to claim 18, further comprising:
a second dielectric layer, located over the first dielectric layer and covering at least a portion of the first dielectric layer.

20. The electroabsorption modulator according to claim 18, wherein the first dielectric layer further comprises a periphery portion, the periphery portion surrounding the central portion, wherein a second thickness of the periphery portion of the first dielectric layer is less than the first thickness.
